(19) United States
(12) Patent Application Publication
(10) Pub. No.: US 2026/0161931 A1
(43) Pub. Date: Jun. 11, 2026

(54) UPDATING USER-SPECIFIC GENERATIVE MODEL CONDITIONING DATA AT USER REQUEST

(71) Applicant: GOOGLE LLC, Mountain View, CA (US)

(72) Inventors: Carsten Isert, Zurich (CH); Patrick Andreas Zoechbauer, Zurich (CH)

(21) Appl. No.: 18/972,171

(22) Filed: Dec. 6, 2024

(51) Int. Cl. G06N 3/0475

(52) U.S. Cl. CPC G06N 3/0475

(57) ABSTRACT

Implementations are described herein for updating user-specific generative model conditioning data at users' requests. In various implementations, a first input prompt is assembled to include user-specific conditioning data (USCD) built from past user interactions and more recent dialog turns between the user and a generative model application. The first input prompt is processed by one or more generative models to generate output identifying out-of-date portions of the USCD. Based on these identified portions, the USCD is updated and stored to reflect the new dialog turns. This updated USCD is then used for subsequent generative model queries.

### BACKGROUND

Generative models such as single-modal or multi-modal large language models (LLMs) (e.g., vision language models or “VLMs”) can be used to process sequences of input tokens to generate sequences of output tokens. Generative models are applicable across a wide range of tasks. For example, generative models are increasingly being used to power automated assistants (also referred to as “virtual assistants” or “chatbots”), which enable humans (which are referred to as “users” when interacting with automated assistants) to participate in natural language dialogs with automated assistants. Some generative models that are pretrained/trained using web-scale data are referred to as “foundation” models. Recent iterations of generative models are able to process increasingly large amounts of data at once. Put another way, recent generative models have increasingly growing “context windows.”

### SUMMARY

When users engage with automated assistants, they may expect the automated assistants to “learn” from interactions with the user so that the automated assistants become increasingly personalized (or “bespoke”). For example, a vegetarian user may expect his or her automated assistant to learn—from an explicit input by the user and/or from observing various interaction(s) between the user and computing device(s) over time—that the user does not wish to receive restaurant recommendations for establishments with few or no vegetarian options.

As another example, users often use automated assistants to control smart appliances such as lights, thermostats, locks, media playback devices, etc. Those users may expect that as they make changes to their smart appliances—whether it be commissioning new appliances, altering existing appliances, or decommissioning existing appliances—the automated assistant will be made aware of those changes and respond to future requests appropriately. For example, if a user adds a smart light to a kitchen, the user may expect that future invocations of “turn on all the kitchen lights” will cause the new smart light to be turned on, too.

Some automated assistants may be personalized by building and maintaining a personalized user data structure, e.g., in the form of one or more database tables, a personalized knowledge graph, etc. Such a personalized user data structure may be updated manually by the user and/or automatically, e.g., when the user alters a smart appliance configuration, accepts or rejects a recommendation (e.g., of digital content, restaurant, etc.), engages in patterns of behavior (e.g., repeatedly eating the same type of cuisine), etc. However, conventional automated assistants may access personalized user data structures programmatically and/or using predefined actions, which can become unwieldy as the personalized data structure grows with increasingly heterogeneous data (e.g., emails, text messages, various user interactions with computing devices, etc.).

Implementations described herein relate to building and maintaining “user-specific conditioning data” (USCD) in association with individual users, as well as using USCD in conjunction with generative artificial intelligence (AI) to generate content that is tailored to individual users. The USCD may be built and/or maintained by accumulating data derived from various types of user interactions with computing devices. These user interactions can include, for instance, users sending/receiving electronic correspondence such as emails or texts, users reconfiguring smart appliances (e.g., lights, thermostats, locks, televisions, speakers, blinds, garage door openers, etc.), individuals submitting search queries and/or consuming content responsive to search queries, individuals' browsing data, individual engagement with social media, individual engagement with generative models (including any modality of data provided by the individual to the generative model, or generated using the generative model), individuals' consumption of documents and/or media (e.g., images, videos, games, podcasts, music, etc.), individuals' engagement with mapping applications (including accumulated locations, saves places, etc.), device and/or application configuration (e.g., applications installed on a mobile device, integration between applications, mobile device settings, etc.), data derived from documents created and/or edited using productivity software (e.g., word processing documents, spreadsheets, presentations), task lists, shopping lists, chats (e.g., SMS, MMS), reviews the individuals have posted (e.g., about restaurants, recipes, products), photos (including captions and/or detailed summaries of photos generated using generative models such as VLMs), payments made and/or received by individuals (including comments or metadata provided with those payments), third party software, personal uniform resource locators (URLs), and so forth.

While many examples described herein related to users interacting with generative model-powered automated assistants, this is not meant to be limiting. Techniques described herein are applicable outside of the automated assistant context. For example, techniques described herein may enable users of AI-powered productivity software, such as word processors, spreadsheets, presentation programs, etc., to have increasingly bespoke experiences. As another example, users engaging with a general-purpose generative model interaction interface (e.g., not specifically an automated assistant) such as might be provided via a web browser may benefit from techniques described herein.

As yet another example, an integrated development environment (IDE) or other application in which source code can be created/edited may include a generative AI assistant configured with selected aspects of the present disclosure. As yet another example, a robot that can be controlled using natural language may benefit from techniques described herein. Conditioning the robot's behavior on the individual's attributes and/or context represented by the individual's USCD may cause the robot to behave in a manner that is not only responsive to the individual's explicit command, but also is aware of the individual's personal preferences, context, attributes, etc. For example, if the individual asks the robot, “can you get me something to drink,” an underlying world model (implemented as a generative model) of the robot may be able to ascertain the individual's personal preferences and bring back a beverage that the individual is more likely to enjoy.

Techniques described herein may give rise to various technical advantages. For example, techniques described herein may leverage new user interactions between a user and a client device to update a user's USCD, such as by adding new user attributes that, if accounted for when the individual engages with generative AI, would benefit the user's experience by making responses more useful and/or tailored to a user's specific situation. This in turn may decrease the interaction required, thereby reducing the use of computational resources such as memory and processor cycles.

Techniques described herein may also enable generative model input prompts (or context) to be shortened because the raw data that is used to formulate USCD may be compressed in various ways, such that the resulting USCD is more concise than the underlying raw data, or than what a user may provide as a manual prompt. For example, natural language describing aspects or attributes of a user, such as electronic correspondence, consumed documents, database tables, etc., may be condensed using techniques such as generative model-based textual summarization prior to being assembled into the USCD. Additionally or alternatively, the USCD could be formulated as reduced-dimensionality, semantically-rich embedding(s) that can be represented using far fewer input tokens than, for instance, natural language, database tables, logs of user queries, emails or other electronic correspondence in native formats, etc. Having concise USCD may decrease-potentially to a significant degree the amount of calculations required to process the input prompts, thereby decreasing computational cost/load and/or latency experienced by the user.

### BRIEF DESCRIPTION OF THE DRAWINGS

FIG. 1 depicts an example environment in which techniques described herein may be implemented.

FIG. 2 depicts an example of how various components of FIG. 1 may cooperate to conduct selected aspects of the present disclosure.

FIG. 3 depicts an example of how techniques described herein may be implemented on various components of FIG. 1 to implement selected aspects of the present disclosure.

FIG. 4A and FIG. 4B depict an example of how techniques described herein may be used to monitor an ongoing dialog between an individual and a generative model-powered automated assistant (e.g., 120) and update user-specific conditioning (USCD) data.

FIG. 5 depicts an example method for practicing selected aspects of the present disclosure.

FIG. 6 is a block diagram of an example computer system.

### DETAILED DESCRIPTION

Implementations described herein relate to building and maintaining “user-specific conditioning data” in association with individual users, as well as using user-specific conditioning data in conjunction with generative artificial intelligence (AI) to generate content that is tailored to individual users. User-specific conditioning data (often abbreviated herein to “USCD”) may be built and/or maintained by accumulating and/or monitoring data derived from various types of user interactions with computing devices. These user interactions can include, for instance, users sending/receiving electronic correspondence such as emails or texts, users reconfiguring smart appliances (e.g., lights, thermostats, locks, televisions, speakers, blinds, garage door openers, etc.), users submitting search queries and/or consuming content responsive to search queries, user engagement with social media, users creating and/or consuming documents, and so forth. USCD itself may be expressed in various forms, such as a textual description/summary of the individual's attributes, tokens/embeddings encoding the individual's attributes, images and/or other modalities that convey the individual's attributes, or any combination thereof.

More particularly, but not exclusively, implementations described herein relate to updating an individual's USCD based on statements and/or commands issued by the individual to a generative model-powered application. Such a generative model-powered application may take various forms, such as an automated digital assistant, another AI-powered application that interprets natural language such as speech or text, etc., productivity software, an IDE, and so forth. Updating the individual's USCD may involve replacing and/or modifying existing text/embeddings in the USCD with new embeddings/text generated from statements issued by the individual to the generative model-powered application. Updating the individual's USCD further (or alternatively) may involve deleting/altering existing text/embeddings in the USCD, such as when the individual declines content generated by the generative model-powered application that matches a portion of the USCD.

Statements issued by individuals that may trigger techniques described herein may take various forms, including but not limited to explicit commands to update USCD (e.g., “Please update my profile to indicate that I am allergic to cashews”), questions (e.g., “will you remember for multi-word variable names, I prefer to separate the words using underscores, rather than concatenating the words and making the first letter of each word capital?”), and/or statements of facts (e.g., “I recently learned I'm allergic to cashews”), to name a few. Additionally or alternatively, rejection or selection of generative model output may be used to update portion(s) of an individual's USCD. For example, after a user provides input rejecting content generated by one or more generative model-powered applications, this input may be used to delete corresponding portions of the user' USCD. As another example, after a user provides input selecting content generated by one or more generative model-powered applications, this input may be used to update corresponding portions of the user' USCD.

In some implementations, an individual or “user” may engage in a multi-turn dialog with the generative model-powered application. During one or more dialog turns in which the user issues a next query, and/or a generative model-based response is provided, that query and/or the corresponding response may be evaluated to determine whether the user's USCD should be updated. For example, a first input prompt may be assembled to include data indicative of: (i) new dialog turn(s) between the user and the generative model-powered application; and (ii) the user's USCD. Data indicative of new dialog turn(s) may include any data that can be obtained, extracted, and/or derived from (a) the user's input to the generative model, (b) responsive content generated using the generative model, and/or (c) the user's reaction/response to the responsive content (e.g., selecting a graphical “thumbs up” element, selecting one candidate draft over another, selecting a graphical “thumbs down” element, natural language explicitly rejecting the responsive content, etc.). In some implementations, the first input prompt may also be assembled to include a request to evaluate the data indicative of the new dialog turn(s) against the user's USCD to determine whether any portions of the USCD need updating based on the new dialog turn(s). In some such implementations, this request to evaluate may be added automatically, e.g., without explicit user input (and perhaps without the user even being made aware).

The first input prompt may be processed using generative model(s) (which as described herein may be selected by another component first) to generate the first generative model output. The first generative model output may identify portion(s) of the user's USCD that are out-of-date or “stale” in view of the dialog turn(s) between the user and the generative model-powered application. Based on the stale portion(s) of USCD, the USCD may be updated to reflect data exchanged in the new dialog turn(s) between the user and the application. This is not limited to replacing out-of-date information with up-to-date information. There may be instances in which both out-of-date and up-to-date information are both maintained in the USCD (e.g., as part of a timeline that includes timestamped user interactions) to provide historical context about an individual. For example, if the individual lives in China for some time, then moves to Switzerland, their USCD may be updated to reflect both that they used to live in China and now live in Switzerland. This updated USCD may be stored for subsequent use when the user submits a new generative model query.

In some implementations, the USCD may be updated on demand or asynchronously, e.g., as part of a batch job that is performed during downtime, when a threshold amount/number of new user interactions/dialog turns are accumulated, etc. Additionally, in some implementations, the USCD may be updated programmatically or heuristically, e.g., by replacing the identified stale portions with superseding data from the new dialog turn(s), by deleting the identified stale portions from the USCD and appending the superseding data from the new dialog turn(s) to the end of the USCD, etc.

In other implementations, generative model(s) may be leveraged to update the USCD. For example, a second input prompt may be assembled with data indicative of (i) the portion(s) of the USCD identified as stale, and (ii) the new dialog turn(s) between the user and the application. The second input prompt may also be assembled (e.g., automatically without user input) to include a request to update the USCD based on the new dialog turn(s), and in some cases, the entirety of the user's pre-update USCD. The second input prompt may then be processed using generative model(s) to generate second generative model output that includes, for instance, new versions of the identified stale portions of the USCD. These new versions may then be incorporated into the portion(s) of the USCD identified as stale. Notably, the updated USCD may retain other portions that remain unaltered in view of the new dialog turn(s) between the user and the application.

As noted herein, an individual's USCD may be built over time based on past user interactions between a user and one or more computing devices. In some implementations, these past user interactions, or at least the data indicative thereof, that form the basis of the individual's USCD may be modified in response to the individual directly modifying their USCD using techniques described herein. For example, in some implementations, the USCD may include or otherwise be associated with mappings between particular portions of the USCD and past user interaction data that spawned the particular portions of the USCD. These may include, for instance, mappings between particular portions of the USCD and past dialog turns between the user and the application that spawned the particular portions of the USCD. If the past dialog turns are stored as entries in a log, then they may be altered based on the new dialog turns between the user and the application. That way, if the individual's USCD is accidentally lost, it can be rebuilt based on accumulated historical user interactions (e.g., maintained as a timeline of individually timestamped user interactions). If these accumulated user interactions are updated as described herein, the rebuilt USCD will be more up-to-date as well.

For example, suppose an individual who initially likes shellfish develops a shellfish allergy. The log of interactions between the individual and their generative AI-powered digital assistant may include early entries in which the user requests recommendations for shellfish restaurants, recipes, etc., and these entries may be accounted for as a preference in the individual's USCD (e.g., “likes shellfish”). However, suppose the individual later provides a statement to the digital assistant that the individual has developed a shellfish allergy. That subsequent statement and the aforementioned mappings may be used to update the individual's USCD to indicate that they are allergic to shellfish. Additionally, in some (but not all) implementations, the subsequent statement and mappings may also be used to locate and modify (e.g., delete) as applicable (e.g., if the individual approves) the earlier log entries that would otherwise evidence an affinity for shellfish. Alternatively, all log entries may be kept in place, but as timestamped entries in a timeline stored in user interactions database 110 or as USCD, it may be possible for a generative model to ascertain that while the individual previously could cat shellfish, they no longer can.

USCD may be mapped to other types of user interactions as well. For example, an individual may have a profile associated with their identity/email. The user may use this profile to control smart appliances (e.g., light bulbs, locks, blinds, thermostats, garage door openers, smart speakers, etc.) in a smart home. To enable a generative model-powered digital assistant access to these smart appliances (e.g., so that the individual can control them using voice commands), in some cases, the individual's USCD may include configuration data (e.g., in textual form, JSON form, XML form, etc.) about these smart appliances.

One way the individual can move, remove, change settings of, decommission, or otherwise change a smart appliance is to log into a smart home application and manage their smart appliances. However, with techniques described herein, the individual may, assuming they've explicitly opted into such functionality, manage the configuration of smart appliances using a generative model. For instance, the individual could issue a command to their generative model-powered digital assistant, such as “I've moved the smart fandelier from the kitchen to the living room.” Using techniques described herein, the individual's USCD may be updated to change the location of the fandelier. Additionally, the mappings in or associated with the USCD may be used to propagate those changes to the individual's smart home configuration profile to effect the change there as well, without the user necessarily having to log into the smart home application and make the change manually.

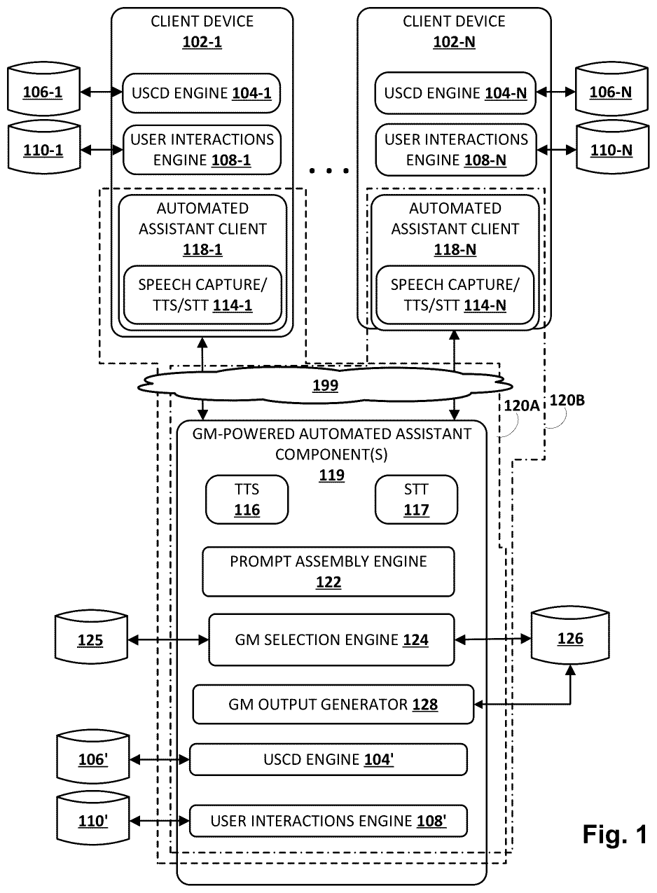

Now turning to FIG. 1, an example environment in which techniques disclosed herein may be implemented is illustrated. The example environment includes a plurality of client computing devices 102-1 to 102-N. Each client device 102 may execute a respective instance of an automated assistant client 118. One or more GM-powered automated assistant components 119 may be implemented on one or more computing systems/servers (collectively referred to as a “cloud” computing system) that are communicatively coupled to client devices 102-1 to 102-N via one or more local and/or wide area networks (e.g., the Internet) indicated generally at 199. Moreover, one or more GM-powered automated assistant components 119 might alternatively be implemented at one or more of client devices 102.

An instance of an automated assistant client 118, by way of its interactions with one or more GM-powered automated assistant components 119, may form what appears to be, from the user's perspective, a logical instance of an automated assistant 120 with which the user may engage in a human-to-computer dialog. Two instances of such an automated assistant 120A, 120B are depicted in FIG. 1 in dashed line. It thus should be understood that each user that engages with an automated assistant client 118 executing on a client device 102 may, in effect, engage with his or her own logical instance of an automated assistant 120. For the sakes of brevity and simplicity, the term “automated assistant” as used herein as “serving” a particular user will refer to the combination of an automated assistant client 118 executing on a client device 102 operated by the user and one or more GM-powered automated assistant components 119. It should also be understood that in many cases, automated assistant 120 may respond to a request from any user regardless of whether the user is actually “served” by that particular instance of automated assistant 120.

The client devices 102 may include, for example, one or more of: a desktop computing device, a laptop computing device, a tablet computing device, a mobile phone computing device, a computing device of a vehicle of the user (e.g., an in-vehicle communications system, an in-vehicle entertainment system, an in-vehicle navigation system), a standalone interactive speaker, a smart appliance such as a smart television, and/or a wearable apparatus of the user that includes a computing device (e.g., a watch of the user having a computing device, glasses of the user having a computing device, a virtual or augmented reality computing device), a robot, etc. Additional and/or alternative client computing devices may be provided.

In various implementations, an individual communicates with automated assistant 120 utilizing any one of a plurality of client computing devices that collectively form a coordinated ecosystem of client computing devices. In some cases, the coordinated ecosystem of client devices may be linked to the individual via a user profile of the individual that is associated with, for example, the individual's email address. In some such implementations, the individual's user-specific conditioning data (USCD) may also be linked with this same profile, so that that the individual's USCD may be used when the individual operates any client device of their coordinated ecosystem to interact with automated assistant 120, or more generally, to interact with generative model(s).

Automated assistant 120 engages in human-to-computer dialog sessions with a user via user interface input and output devices of one or more client devices 102-1 to 102-N. To preserve user privacy and/or to conserve resources, in many situations a user must often explicitly invoke the automated assistant 120 before the automated assistant will fully process a spoken utterance. The explicit invocation of the automated assistant 120 can occur in response to certain user interface input received at the client devices 102. For example, user interface inputs that can invoke the automated assistant 120 via the client devices 102 can optionally include actuations of a hardware and/or virtual button of the client device 102. In some implementations, the automated assistant client may include a component 114 that is configured to capture the user's utterance and either convert it to text using text to speech (TTS) processing, or in some cases, convert the audio directly into semantically rich embeddings, e.g., using an end-to-end transformer-based architecture (with text being generated, if at all, as a byproduct). The component 114 may also include speech to text (STT) functionality for converting text (or embeddings) to synthetic audio such as speech. For example, textual content received from GM-powered automated assistant components 119 may be processed using the STT functionality of component 114 and output as audio content using one or more speakers.

Client devices 102-1 to 102-N may also include user-specific conditioning data (USCD) engines 104-1 to 104-N and user interactions engines 108-1 to 108-N that are operably coupled, directly or indirectly, with user-specific conditioning (USCD) databases 106-1 to 106-N and user interactions databases 110-1 to 110-N, respectively. Additionally or alternatively, in some implementations, cloud-based instances of these components may be provided. For instance, there may be a cloud-based USCD engine 104′, a cloud-based USCD database 106′, a cloud-based user interactions engine 108′, and/or a cloud-based user interactions database 110′. Anytime any of the reference numerals 104 to 110 are used herein without any additional context (e.g., “-1” or a single quote), that may refer to either the local instance (e.g., 104-1, 106-1, 108-1, 110-1) or the cloud-based instance (e.g., 104, 106, 108, 110).

USCD engine 104 may be configured to build and/or maintain USCD for each user based on data received from user interactions engine 108 and/or from other sources, such as automated assistant client 118. USCD may be indicative of a wide variety of an individual's attributes, including but not limited to preferences, observed behavior, content of electronic correspondence, smart appliance configurations, user-centric coordinated ecosystems of computing devices, schedules, travel history and/or any combination thereof. As noted elsewhere herein, individuals may have complete control over which user interactions (and hence, which of their attributes) are incorporated into their USCD, and which user interactions are not.

USCD engine 104 may store USCD in USCD database 106 in various forms and/or modalities, such as natural language text, structured text such as extensible markup language (XML) or JavaScript Object Notation (JSON), semantically-rich embeddings/tokens, images, videos, and/or any combination thereof. In various implementations, USCD engine 104 may represent user interactions in USCD in different ways. For example, USCD engine 104 may incorporate data indicative of new user interactions into USCD in raw form, whereas previous user interactions may be summarized in the USCD as text/embeddings. In some instances, those new user interactions may be subsequently summarized into text/embeddings when convenient/during downtime. In some implementations, USCD engine 104 or other components herein may formulate USCD to be condensed relative to raw data from which it is derived. For instance, electronic correspondence and/or textual documents consumed by an individual may be summarized using generative model(s) into abridged textual summaries and/or encoded into reduced-dimensionality embedding(s) before being stored as USCD in database 106.

In some implementations, USCD stored in USCD database 106 may be associated with various metadata. This metadata may include, for instance, mappings between portions of the USCD and the underlying user interactions (e.g., raw data) that spawned those portions of the USCD, which are described elsewhere herein. Additionally or alternatively, in some implementations, the metadata associated with USCD may include timestamps of when, for instance, those portions were added to the USCD or last modified. In some instances, these timestamps may be used as mappings between portion(s) of the USCD and an underlying user interactions timeline that is stored, for instance, in user interactions database 110. The USCD metadata may additionally or alternatively include confidence measures associated with individual pieces of data. For instance, a search engine query seeking vegetarian restaurants may be assigned less confidence than an explicit statement from an individual that he or she is a vegetarian. This may be because, for instance, the search engine query is capable of multiple interpretations, such as the individual was seeking a restaurant for a vegetarian friend or colleague. The explicit statement is less ambiguous, and therefore may be assigned a greater confidence measure.

In many implementations, USCD engine 104 may be required to solicit explicit and/or implicit permission from individuals prior to storing data received from user interactions engine 108 as part of USCD in USCD database 106. For example, USCD engine 104-1 may cause client device 102-1 to audibly and/or visually prompt the individual to expressly indicate their willingness to have data provided as USCD by USCD engine 104 and/or user interactions engine 108 be stored by USCD engine 104 in USCD database 106. By opting into such use of their personal data, the individual's privacy and/or security in using such data is maintained. Additionally or alternatively, in some implementations, an individual's USCD may be encrypted before being transmitted to GM-powered automated assistant components 119 and/or shared with other components, such as the cloud-based USCD engine 104′ and corresponding cloud-based USCD database 106′, or the cloud-based user interactions engine 108′ and corresponding cloud-based user interactions database 110′.

In various implementations, and with the individual's express permission, user interactions engine(s) 108 may be configured to monitor various types of user interactions between the individual and one or more computing devices 102-1 to 102-N, and store data indicative of relevant interactions in user interactions database 110. In other implementations, USCD engine(s) 104 may handle all functions attributed herein to user interactions engine(s) 108, and user interactions engine(s) 108 may be omitted.

As one example, user interactions engine 108 (or USCD engine 104 in some implementations) may monitor emails, text messages, and/or other forms of electronic content sent or received, e.g., via network 199, by user device 102-1. If the individual receives an email about a flight cancellation, user interactions engine 108 may store data indicative of this email in user interactions database 110. USCD engine 104 may use this data to update the individual's USCD in USCD database 106 to reflect the flight cancellation. Alternatively, USCD engine 104 may monitor emails and update USCD directly, and the user interactions engine 108 may be omitted. The flight cancellation might be used during a subsequent interaction between the individual and a generative model 126. For example, the individual might ask the automated assistant 120 “What is my travel schedule for next week?” The automated assistant 120, using generative model 126, would then be able to provide a more accurate and relevant response, taking into account the flight cancellation.

As another example, user interactions engine 108 (or USCD engine 104 in some implementations) may monitor search engine queries, search engine responses, automated assistant queries, automated assistant responses, and/or other forms of search results received, e.g., via network 199, by user device 102-1. As an example, if an individual searches for vegetarian restaurants, user interactions engine 108 may store data indicative of this query in user interactions database 110. USCD engine 104 may use data indicative of such a search query to update the individual's USCD in USCD database 106 to reflect the user's preference for vegetarian cuisine. The individual's preference for vegetarian cuisine, as it is reflected in the individual's USCD, might be used during a subsequent interaction between the individual and a generative model 126 by providing the individual with restaurant recommendations that are vegetarian-friendly. For example, if the individual asks, “What are some good restaurants near me?”, the generative model 126 could take into account the individual's preference for vegetarian cuisine and recommend restaurants that have a large selection of vegetarian dishes.

As yet another example, user interactions engine 108-1 (or USCD engine 104 in some implementations) may monitor content consumed, e.g., viewed, listened to, or otherwise experienced by a user device 102-1 to 102-N. For example, if a user watches an online video about a specific topic, user interactions engine 108 may store data indicative of this video in user interactions database 110. This data can then be used to update the user's USCD in USCD database 106 to reflect the user's interest in that topic. As another example, if a user listens to a podcast episode about a specific event, user interactions engine 108 (or USCD engine 104 in some implementations) may store data indicative of this podcast episode in user interactions database 110. USCD engine 104 may use this data to update the user's USCD in USCD database 106 to reflect the user's awareness of that event. If the user later asks the automated assistant 120 “What is the latest news about the event?”, the automated assistant will be able to provide more relevant information based on the user's awareness of the event from the podcast episode.

As yet another example, user interactions engine 108 (or USCD engine 104 in some implementations) may monitor user preferences and/or other user feedback explicitly submitted by the user, e.g., via automated assistant client 118 or otherwise. User preferences that might be captured and incorporated into the USCD include, but are not limited to, preferences for specific types of content (e.g., news, entertainment, music, etc.), preferences for specific topics or genres (e.g., sports, cooking, history, etc.), preferences for specific languages, preferences for specific styles or formats (e.g., formal, informal, casual, etc.), preferences for specific levels of detail or complexity, preferences for specific types of responses (e.g., factual, creative, humorous, etc.), preferences for specific sources of information, preferences for specific types of interactions (e.g., text-based, voice-based, visual, etc.), preferences for specific levels of personalization, preferences for specific levels of privacy, preferences for specific types of assistance (e.g., task-oriented, informational, conversational, etc.), preferences for specific time periods or contexts (e.g., work, home, travel, etc.), preferences for specific individuals or groups (e.g., family, friends, colleagues, etc.), and/or preferences for specific locations or settings.

As yet another example, user interactions engine 108 (or USCD engine 104 in some implementations) may monitor changes made to smart appliance configuration(s) by user device(s) 102-1 to 102-N. Suppose a user adds a new smart light to their kitchen. User interactions engine 108 may store data indicative of this change in user interactions database 110. This data can then be used to update the user's USCD in USCD database 106 to reflect the new configuration of the user's smart appliances. The user's new smart light in the kitchen would be reflected in the user's USCD. When the user asks the automated assistant to “turn on all the kitchen lights” the automated assistant will now include the new smart light in its response, turning it on along with the other lights. Changes made to smart appliance configurations can take a variety of different forms, including but not limited to adding, modifying, and/or removing a smart appliance, installing or removing a software application that interacts with the smart appliance (e.g., a security application, a smart home application, a “smart” thermostat application, etc.), modifying and/or adjusting settings and/or parameters of the smart appliance, modifying and/or adjusting settings and/or parameters of the software application that interacts with the smart appliance, etc.

As yet another example, user interactions engine 108 (or USCD engine 104 in some implementations) may monitor locations and/or trajectories of locations accumulated with prior user consent by one or more client devices 102-1 to 102-N. For example, if an individual frequently visits a particular neighborhood, their USCD may include a record of these visits. If the individual later asks the automated assistant 120, “I want to try something new,” the automated assistant could use the individual's location history to suggest locations outside of their usual neighborhood. If the individual later decides to opt out of having their locations tracked, accumulated locations may be deleted from the individual's user interactions database 110. This may trigger implementations described herein to follow mappings from those deleted trajectories to the individual's USCD, where corresponding portion(s) of the USCD can likewise be deleted. Consequently, if the individual later asks the automated assistant 120, “I want to try something new,” the individual's past travels will no longer be accounted for in the generative model response.

Alternatively, the individual may issue a generative model request, e.g., via automated assistant client 118, to remove one or more trajectories of locations. This may trigger techniques described herein to not only remove corresponding portions from the individual's USCD but, if applicable, to also follow mappings to underlying data sources and make similar changes. Suppose the individual wishes to conceal their presence in a particular neighborhood known for jewelry stores because the individual doesn't wish to leave their partner any clues that the individual has been jewelry shopping. The individual may issue the command, “forget that I've spent time in <hypothetical> neighborhood.” Data indicative of the relevant travel trajectories may be removed from both the individual's USCD and, using the mappings associated with the individual's USCD, the underlying travel trajectories (e.g., stored in association with a fitness application). More generally, an individual may issue a generative model request that removes any type of data from other original sources.

Similar to USCD engine 104, in various implementations, user interactions engine 108 may be required to solicit explicit and/or implicit permission from an individual prior to monitoring user interaction(s) between the individual and computing devices 102-1 to 102-N and storing data indicative thereof in user interactions database 110. For example, user interactions engine 108 may cause client device 102-1 to audibly and/or visually prompt the individual to expressly indicate their willingness to have data provided as user interaction(s) by user interactions engine 108 be stored in user interactions database 110. By being able to opt in and/or out of such use of their personal data, the individual's privacy and/or security in using such data is maintained. In some implementations, an individual's user interaction(s) may be stored only in local user interactions database 110, or may be encrypted before being transmitted to GM-powered automated assistant components 119 and/or shared with other components.

GM-powered automated assistant component(s) 119 may include a TTS component 116, an STT component 117, a prompt assembly engine 122, a GM selection engine 124, a classifier 125, a GM output generator 128, a cloud-based USCD engine 104′ and corresponding database 106′, and a cloud-based user interactions engine 108′ and corresponding user interactions database 110′. TTS component 116 may be configured to leverage the virtually limitless resources of the cloud computing system to convert textual data (e.g., natural language responses formulated by automated assistant 120) into computer generated speech output. In some implementations, TTS component 116 may provide the computer generated speech output to client device 102 to be output directly, e.g., using one or more speakers. TTS component 116 may use any appropriate speech synthesis technique to generate computer generated speech output from textual data including, but not limited to, concatenative synthesis, unit selection synthesis, diphone synthesis, domain-specific synthesis, formant synthesis, Hidden Markov Model (HMM)-based synthesis (e.g., Gaussian mixture core network synthesis), sinewave synthesis, or any combination thereof. In some implementations, the TTS component 116 may be implemented using an end-to-end transformer-based architecture.

STT component 117 may be configured to convert a spoken utterance into text data. In some implementations, STT component 117 may convert an utterance into multiple text segments, e.g., phonemes, word pieces, etc., that are string of characters corresponding to the utterance. STT component 117 may convert the utterance into text data using various speech recognition techniques, such as hidden Markov model (HMM) techniques, dynamic time warping (DTW)-based techniques, neural network-based techniques, or other techniques. In some implementations, the STT component 117 may be implemented using an end-to-end transformer-based architecture.

Prompt assembly engine 122 may be configured to assemble generative model prompts (or “context”) that can then be used by GM selection engine 124 to select one or more GMs from GM database 126, and that can be used by GM output generator 128 to generate generative model output. Prompt assembly engine 122 may assemble generative model prompts from various data sources, such as a user's explicit or implicit generative model query. An explicit generative model query may be issued via the user typing or speaking the query. An implicit generative model query may be issued automatically, e.g., in response to various events that may occur in a software application, in response to particular sensor data, etc.

In addition to an individual's explicit or implicit generative model query, prompt assembly engine 122 may assemble other data into a generative model prompt. For example, prompt assembly engine 122 may assemble data indicative of the individual's USCD, received from cloud-based USCD engine 104′ or a local USCD engine 104-1 to 104-N into the generative model prompt. In some implementations, a cloud-based USCD engine 104′ may obtain this USCD from database 106-1 of client device 102-1 and may temporarily store it in a cloud-based USCD database 106′. Additionally or alternatively, cloud-based USCD engine 104′ may store individuals' USCD data in cloud-based USCD database 106′ on a long term basis, while taking steps to ensure the privacy and security of the individuals' USCD. In some such implementations, the individuals may be required to provide express permission before their USCD can be stored in cloud-based USCD database 106′. Additionally or alternatively, in some implementations, USCD stored in database 106′ (or locally at 106) may be stored in a form that is not readily interpretable by humans, such as in continuous embedding form, encrypted form, hashed form, etc.

As noted above, GM selection engine 124 may be configured to select one or more generative models 126 that are suitable for generating content responsive to, for instance, an individual's generative model query (or even to a generic search query), to an implicit query, and/or to a request to update an individual's USCD based on new user interaction(s). In some implementations, GM selection engine 124 may utilize a classifier 125 to identify a generative model that is most likely to accurately and efficiently respond to a generative model query provided by automated assistant 120 and an individual that provided the generative model query. Such a classifier may itself be a generative model (e.g., an LLM), or it may be another type of machine learning model that is trained to classify or otherwise generate scores for different available generative models 126. As one example, if an individual's query includes both text and an image (e.g., “modify this image to delete the clouds”), the GM selection engine 124 may select a generative model that is suitable for generating synthetic image data, such as a diffusion model. Additionally or alternatively, GM output generator 128 may include a plurality of generative model agents, each configured to perform different task(s) using different generative models, and the GM selection engine 124 may select the most suitable GM agent.

GM output generator 128 may be configured to process a prompt using one or more generative models selected by GM selection engine 124 from GM database 126 (GM database and generative models themselves will both be interchangeably referenced using 126) to generate content that is responsive to, for instance, a generative model query from automated assistant client 118 at a client device 102, or to an implicit query to update an individual's USCD based on new user interaction(s). To this end, GM output generator 128 may have access to one or more generative models in database 126, and may apply those generative model(s) that are selected by GM selection engine 124.

GM database 126 may include a variety of generative models, such as foundation models, fine-tuned models, and task-specific models. Foundation models may be pretrained on large datasets of various types of data, such as text, code, images, videos, audio, etc. Foundation models can be used for a wide range of tasks. Fine-tuned models are foundation models that have been further trained on a specific dataset, such as a dataset of customer service conversations or a dataset of medical records. Task-specific models are designed for a specific task, such as generating code, translating languages, or writing different kinds of creative content. Generative models can be single-modal or multi-modal. Single-modal models process and generate data of a single type, such as text or images. Multi-modal models process and/or generate data of multiple types, such as text and images, or text and audio. Generative models may or may not be transformer-based, and may be encoder-only, decoder-only, or encoder-decoder. Encoder-only models take an input and produce a representation of that input. Decoder-only models take a representation and produce an output. Encoder-decoder models combine both encoder and decoder components. Some generative models that generate non-textual data may include, for instance, stable diffusion models.

The number of parameters in a generative model can vary significantly depending on the model's complexity and the resources available for its implementation. On a resource-constrained client device like 102, the model may have a smaller number of parameters to optimize performance and reduce memory usage. This is because client devices often have limited processing power and memory compared to cloud servers. In contrast, a generative model implemented on a cloud server like 119 can have a much larger number of parameters due to the availability of extensive computing resources. This allows for more complex models with higher accuracy and capabilities. The choice of parameter size is a trade-off between model performance and resource constraints. For example, on a client device with limited resources, a generative model might have 100 million parameters, while a server-based model could have billions of parameters, enabling more complex and accurate results. Another example is a client device model with 500 million parameters, compared to a server model with 100 billion parameters, showcasing the significant difference in scale and capabilities.

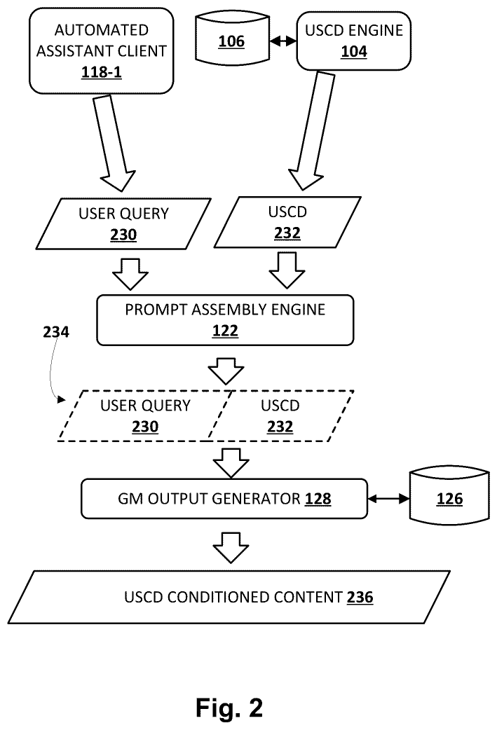

FIG. 2 schematically depicts an example of how various components of FIG. 1 may cooperate to conduct selected aspects of the present disclosure. Beginning at top, USCD engine 104 and automated assistant client 118-1 of client device 102-1 may provide, respectively, data indicative of a user-specific conditioning data (USCD) 232 and a user query 230 to prompt assembly engine 122. Prompt assembly engine 122 may then assemble the USCD 232 and the user query 230 into a generative model prompt 234. While not shown in FIG. 2 for the sake of brevity and simplicity, this generative model prompt 234 may be provided to GM selection engine 124, and GM selection engine 124 may select appropriate generative model(s) 126 and/or GM agents for processing this generative model prompt 234.

Moreover, various other information may or may not be assembled into generative model prompt 234 by prompt assembly engine 122. This other information may, for instance, identify tools (e.g., installed application, web applications (RESTful or RPC)) that are available to perform various functions (e.g., controlling smart appliances at a home or in a vehicle). Additionally or alternatively, this other information may include system instructions (e.g., not provided by the user) on how USCD should be used to personalize or otherwise condition the generative model output. For instance, the system instructions may include a natural language statement such as “When responding to the user's query, make sure to take into account this summary of the user, including the user's preferences, attributes, etc.” In some implementations, the system instructions may include additional requests designed to avoid various negative outcomes. For example, the system instructions may include a request such as “Medical data of the user should not be disclosed to anyone other than the user. Accordingly, don't directly incorporate the user's medical data into your response. At most, allow the user's medical data to influence other output you generate, without explicitly mentioning the medical data itself.”

Referring back to FIG. 2, prompt assembly engine 122 (or GM selection engine 124) may provide generative model prompt 234 to GM output generator 128. GM output generator 128 may then input the generative model prompt 234 into one or more generative models of GM database 126 to generate output that includes USCD-conditioned content 236. USCD conditioned content 236 may include content that is both responsive to user query 230 and conditioned upon USCD 232.

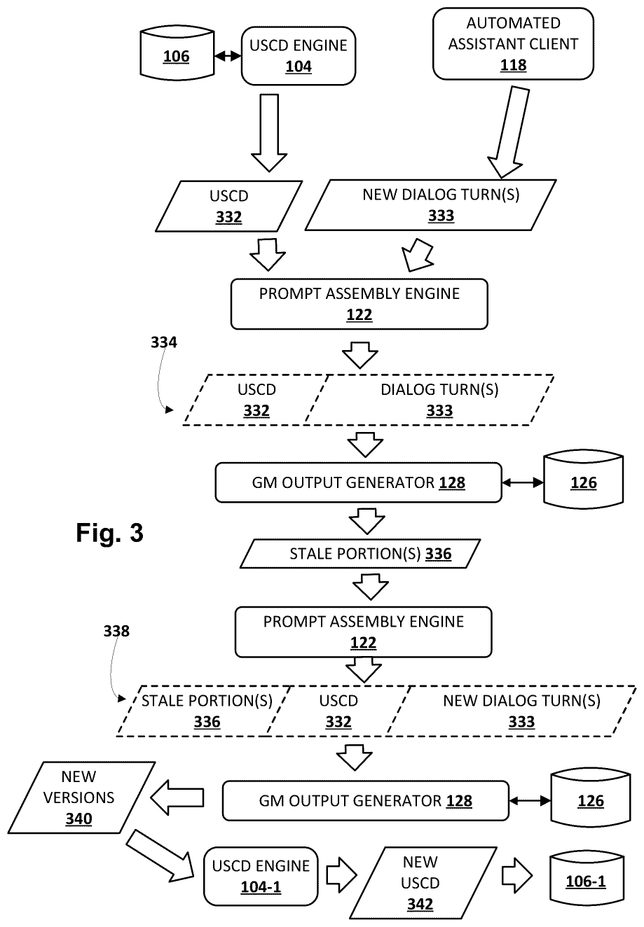

FIG. 3 schematically depicts an example of how techniques described herein may be implemented on various components of FIG. 1 to implement selected aspects of the present disclosure. Various components of FIG. 3 are similar to those in FIG. 2, and therefore, they will be referred to using similar reference numbers as those in FIG. 2. While some components are depicted in FIG. 1 as being part of a client device (e.g., 102-1) and other components are depicted as being part of a server (e.g., 119), this is not meant to be limiting. In various implementations, any of the components depicted in FIGS. 1-3 may be implemented wholly on a client device, wholly on a server, or any combination thereof.

Beginning at the top of FIG. 3, USCD engine 104 and automated assistant client 118-1 of client device 102-1 may provide, respectively, data indicative of a user-specific conditioning data (USCD) 332 and new dialog turn(s) 333 to prompt assembly engine 122. Prompt assembly engine 122 may then assemble the data indicative of USCD 332 and the new dialog turn(s) 333 into a generative model prompt 334. While not shown in FIG. 3 for the sake of brevity and simplicity, this generative model prompt 334 may be provided to GM selection engine 124, and GM selection engine 124 may select appropriate generative model(s) 126 and/or GM agents for processing this generative model prompt 334.

Referring back to FIG. 3, prompt assembly engine 122 (or GM selection engine 124) may provide generative model prompt 334 to GM output generator 128. GM output generator 128 may then input the generative model prompt 334 into one or more generative models of GM database 126 to generate output that includes, among other things, portion(s) 336 of USCD 332 that are rendered out-of-date or stale by the new dialog turn(s) 333. Prompt assembly engine 122 may then assemble a second input prompt 338 that includes data indicative of stale portion(s) 336 and the new dialog turn(s) 333. Second input prompt 338 may also include all or parts (e.g., the non-stale portions) of USCD 332. While once again not depicted in FIG. 3, this second input prompt 338 may be provided to GM selection engine 124, which may then select appropriate generative model(s) 126 and/or GM agents for processing this second input prompt 338.

GM output generator 128 may then process the second input prompt 338 using one or more generative model(s) 126 selected by GM selection engine 124 to generate output that includes, among other things, new version(s) 340 of the stale portion(s) 336 of USCD 332. USCD engine 104-1 may then store a new version of USCD 342 that includes new version(s) of the previous (e.g., stale, formerly applicable, historical, etc.) portion(s) 336 of USCD 332 and, where applicable, remaining portion(s) of USCD that remain up-to-date, in USCD database 106-1.

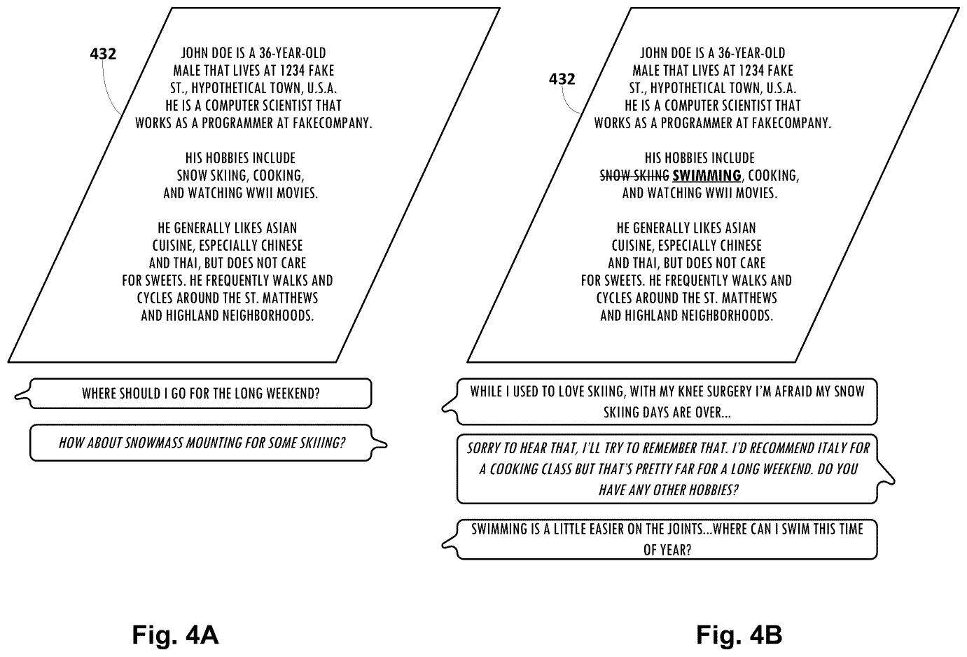

FIGS. 4A and 4B schematically depict an example of how techniques described herein may be used to monitor an ongoing dialog between an individual and a generative model-powered automated assistant (e.g., 120) and update USCD. Starting in FIG. 4A, an instance of USCD 432 associated with an individual named “John Doe” includes various information about John Doe collected over time based on user interactions, including interactions between John Doc and a generative model-powered automated assistant. In this example, the USCD 432 takes the form of a textual summary describing various attributes of John Doe, such as his age (36), address (1234 Face St., Hypothetical Town), occupation (computer scientist), and current role (programmer). USCD 432 describes other attributes of John Doe as well, such as some hobbies (snow skiing, cooking, watching WWII movies), preferences (likes Asian cuisine, especially Chinese and Thai, but does not like sweets) and travel habits determined from underlying accumulated travel trajectories.

At bottom of FIG. 4A, two dialog turns are depicted, one from John Doe to the generative model-powered automated assistant and the other from the generative model-powered automated assistant to John Doe. John Doe asks, “Where should I go for the long weekend?” The generative model-powered automated assistant uses this query and USCD 432 to condition generative model(s) 126 to generate a response that is conditioned to John Doe's attributes. In this example, the response is “How about Snowmass for some skiing?”

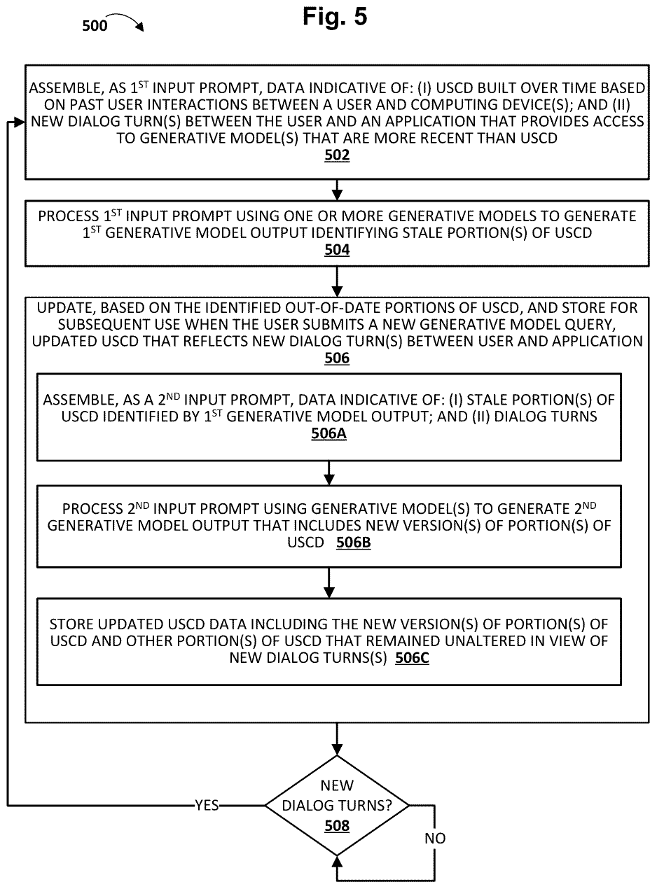

However, for this example, assume that John Doe has injured his knee and is no longer able to ski. FIG. 4B depicts three more dialog turns, one from John Doe to the generative model-powered automated assistant, a response from the generative model-powered automated assistant to John Doe, and another from John Doe back to the generative model-powered automated assistant. Here, John Doe says, “While I used to love skiing, with my knee surgery I'm afraid my skiing days are over . . . ” The generative model-powered automated assistant uses this query and USCD 432 to condition generative model(s) 126 to generate a response that is conditioned to John Doe's attributes. In this example, the response is “Sorry to hear that, I'll try to remember that.” Meanwhile, techniques described herein such as method 500 depicted in FIG. 5 may be performed, e.g., by USCD engine 104, to update John Doe's USCD 432. As shown in 432 in FIG. 4B, USCD 432 has been updated to delete “snow skiing” as a hobby.

Next, the generative model-powered automated assistant attempts to recommend an alternative based on one or more of John Doe's other attributes, in this case his hobby of “cooking.” In particular, the generative model-powered automated assistant provides the additional content, “I'd recommend Italy for a cooking class but that's pretty far for a long weekend. Do you have any other hobbies?” John Doe responds, “Swimming is a little easier on the joints . . . where can I swim this time of year?” The generative model-powered automated assistant again uses USCD 432 to condition generative model(s) to generate a response, which is not shown in FIG. 4B. Meanwhile, techniques described herein may be performed, e.g., by USCD engine 104-1, to update USCD 432 to include the additional data “swimming” as a hobby. This is depicted in FIG. 4B, where USCD 432 has been updated to add the hobby “swimming.”

FIG. 5 depicts an example method 500 for practicing selected aspects of the present disclosure in accordance with various implementations. For convenience, the operations of the flow chart are described with reference to a system that performs the operations. This system may include various components of various computer systems, including GM-powered automated assistant 120, USCD engine 104, automated assistant client 118, etc. Moreover, while operations of method 500 are shown in a particular order, this is not meant to be limiting. One or more operations may be reordered, omitted or added. Method 500 may be triggered on demand or asynchronously, e.g., during downtime, when some threshold number/amount of new dialog turns is accumulated, every few hours, etc. As noted elsewhere herein, in some implementations, new data may be added to USCD in raw form initially, and may later be summarized or otherwise processed into a form (e.g., text, embedding(s)) that is more efficiently stored as part of USCD.

At block 502, the system, e.g., by way of prompt assembly engine 122, may assemble a first input prompt 334 comprising data indicative of user-specific conditioning data (USCD) 332, obtained from USCD engine 104 and USCD database 106, and one or more new dialog turns 333 between the user and an application that provides access to one or more generative models (GMs) 126. The application may take various forms, such as automated assistant 120, productivity software such as a word processor, spreadsheet, or presentation software, cloud-based productivity software, email client, web browser, IDE, etc.

At block 504, the system, e.g., by way of GM output generator 128, may process the first input prompt 334 using one or more generative models 126 selected by GM selection engine 124 to generate first generative model output identifying one or more portions 336 of the USCD 332 that are stale in view of the one or more new dialog turns 333. In textual USCD, for instance, words, phrases, whole sentences, or even paragraphs may be annotated as being stale. In some implementations, metadata may be created alongside the USCD that identifies starting and ending points (e.g., in memory or on a character or word basis) of the stale portion(s) 336. These may include starting and/or ending points of words/phrases/sentences, starting and/or ending points of tokens and/or embeddings, etc.

At block 506, the system, e.g., by way of USCD engine 104, may update, based on the identified out-of-date portions 336 of the USCD 332, and store (e.g., in database 106) for subsequent use when the user submits a new generative model query, updated USCD 342 that reflects one or more of the new dialog turns 333 between the user and the application. As shown in FIG. 5, this updating may in some implementations include, at block 506A, assembling a second input prompt 338 comprising data indicative of the stale portions 336 and the new dialog turns 333. At block 506B, GM output engine 128 may process the second input prompt 338 using one or more generative models 126 to generate second generative model output that includes new versions 340 of the identified portions 336. At block 506C, the system may store (e.g., in database 106) updated USCD data 342 that includes the new version(s) 340 of stale portion(s) 336 of USCD and other portion(s) of USCD that remained unaltered in view of new dialog turns(s) 333.

At block 508, the system may determine whether there are new dialog turns to analyze. More generally, the system may determine whether there are additional generative model inputs to process. If the answer is no, then method 500 may remain at block 508 until new dialog turns are detected. If the answer at block 508 is yes, however, then method may proceed back to block 502, and the process may repeat.

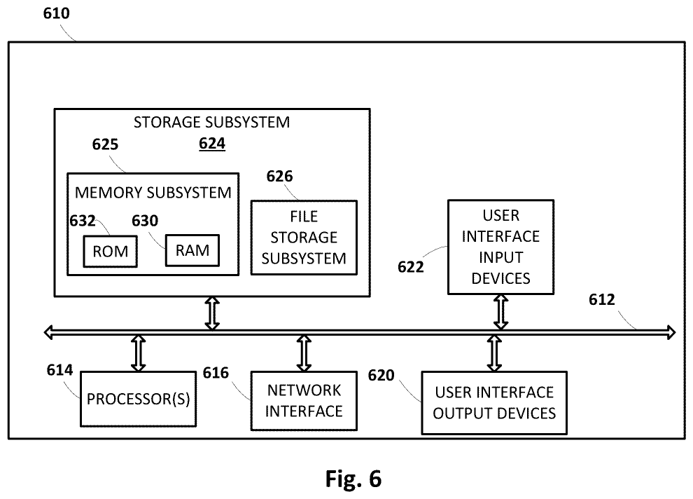

FIG. 6 is a block diagram of an example computer system 610. Computer system 610 typically includes processor(s) 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computer system 610. Network interface subsystem 616 provides an interface to outside networks and is coupled to corresponding interface devices in other computer systems.

User interface input devices 622 may include a keyboard, pointing devices such as a mouse, trackball, touchpad, or graphics tablet, a scanner, a touchscreen incorporated into the display, audio input devices such as voice recognition systems, microphones, and/or other types of input devices. In general, user interface input devices 622 may include any device for inputting information into computer system 610.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, user interface output devices 620 may include any device for outputting information from computer system 610 to the user or to another machine or computer system.

Storage subsystem 624 stores programming and data constructs that provide the functionality of some or all of the modules described herein. For example, the storage subsystem 624 may include the logic to perform selected aspects of the method of FIG. 5. These software modules are generally executed by processor(s) 614 alone or in combination with other processors. Processor(s) 614 may take various forms, such as a central processing unit (CPU), a graphics processing unit (GPU), a tensor processing unit (TPU), a neural processing unit (NPU), and so forth.

Memory 625 used in the storage subsystem 624 can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computer system 610 communicate with each other as intended. Although bus subsystem 612 is shown schematically as a single bus, alternative implementations of the bus subsystem may use multiple busses.

Computer system 610 can be of varying types including a workstation, server, computing cluster, blade server, server farm, or any other data processing system or computing device. Due to the ever-changing nature of computers and networks, the description of computer system 610 depicted in FIG. 6 is intended only as a specific example for purposes of illustrating some implementations. Many other configurations of computer system 610 are possible having more or fewer components than the computer system depicted in FIG. 6.

In situations in which the systems described herein collect personal information about users, or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used. Moreover, features described herein may be activated, deactivated, and reactivated at the individual's discretion.

In various implementations, a method is implemented using one or more processors. Data indicative of user-specific conditioning data (USCD), built over time based on past user interactions between a user and one or more computing devices, and one or more new dialog turns between the user and an application providing access to one or more generative models, may be assembled as a first input prompt. The generative model may be conditioned on the USCD during the new dialog turns, and the new dialog turns may be more recent than the USCD. The first input prompt may be processed using one or more generative models to generate first generative model output. The first generative model output may identify one or more portions of the USCD that are out-of-date in view of the new dialog turns. Based on the portions of USCD identified as out-of-date, updated USCD reflecting the new dialog turns may be updated and stored for subsequent use when the user submits a new generative model query.

In various implementations, the updating may include assembling, as a second input prompt, data indicative of the portions of the USCD identified as out-of-date and one or more of the new dialog turns. The second input prompt may be processed using one or more generative models to generate second generative model output, which may include new versions of the identified portions of the USCD. The new versions of the identified portions of the USCD may be incorporated into the portions of the USCD identified as out-of-date. The updated USCD may further include other portions of the USCD that remained unaltered in view of the new dialog turns.

In various implementations, the new dialog turns may comprise selection by the user of a graphical element that rejects or accepts generative model output rendered at one or more output devices, or natural language provided by the user that rejects or accepts generative model output. The application may comprise an automated digital assistant or productivity software powered by the generative models.

In various implementations, a subsequent inference prompt may be assembled, including data indicative of the updated USCD and one or more subsequent dialog turns between the user and the application. The subsequent inference prompt may be processed using one or more generative models to generate subsequent generative model output, based on the updated USCD in view of the subsequent dialog turns.

In various implementations, the USCD may include mappings from particular portions of the USCD to past dialog turns or past user interaction data that spawned the particular portions of the USCD. These mappings may be used to alter the past dialog turns or past user interaction data based on the new dialog turns. The past user interaction data may include commissioning, altering the configuration of, or decommissioning a smart appliance in a coordinated ecosystem of smart appliances associated with the user.

Other implementations may include a transitory or non-transitory computer readable storage medium storing instructions executable by a processor to perform a method such as one or more of the methods described above. Yet another implementation may include a system including memory and one or more processors operable to execute instructions, stored in the memory, to implement one or more modules or engines that, alone or collectively, perform a method such as one or more of the methods described above.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method implemented using one or more processors, comprising:
assembling, as a first input prompt, data indicative of:
a user-specific conditioning data, wherein the user-specific conditioning data was built over time based on past user interactions between a user and one or more computing devices; and
one or more new dialog turns between the user and an application that provides access to one or more generative models, wherein the generative model was conditioned on the user-specific conditioning data during the one or more new dialog turns, and the one or more new dialog turns are more recent than the user-specific conditioning data;
processing the first input prompt using one or more of the generative models to generate first generative model output, wherein the first generative model output identifies one or more portions of the user-specific conditioning data that are out-of-date in view of the one or new dialog turns between the user and the application;
based on one or more of the portions of user-specific conditioning data that are identified as out-of-date, updating, and storing for subsequent use when the user submits a new generative model query, updated user-specific conditioning data that reflects one or more of the of the new dialog turns between the user and the application.

2. The method of claim 1, wherein the updating comprises
assembling, as a second input prompt, data indicative of:
the one or more portions of the user-specific conditioning data identified as out-of-date, and
one or more of the new dialog turns between the user and the application; and
processing the second input prompt using one or more of the generative models to generate second generative model output, wherein the second generative model output comprises new versions of the one or more identified portions of the user-specific conditioning data.

3. The method of claim 2, further comprising incorporating the new versions of the one or more identified portions of the user-specific conditioning data into one or more of the portions of the user-specific conditioning data identified as out-of-date.

4. The method of claim 3, wherein the updated user-specific conditioning data further comprises other portions of the user-specific conditioning data that remained unaltered in view of the one or more new dialog turns between the user and the application.

5. The method of claim 1, wherein the one or more new dialog turns comprise selection by the user of a graphical element that rejects generative model output rendered at one or more output devices.

6. The method of claim 1, wherein the one or more new dialog turns comprise natural language provided by the user that rejects generative model output rendered at one or more output devices.

7. The method of claim 1, wherein the one or more new dialog turns comprise selection by the user of a graphical element that accepts generative model output rendered at one or more output devices.

8. The method of claim 1, wherein the one or more new dialog turns comprise natural language provided by the user that accepts generative model output rendered at one or more output devices.

9. The method of claim 1, wherein the application comprises an automated digital assistant powered by the one or more generative models.

10. The method of claim 1, wherein the application comprises productivity software powered by the one or more generative models.

11. The method of claim 1, further comprising:
assembling, as a subsequent inference prompt, data indicative of:
the updated user-specific conditioning data, and
one or more subsequent dialog turns between the user and the application; and
processing the subsequent inference prompt using one or more of the generative models to generate subsequent generative model output, wherein the subsequent generative model output is generated based on the updated user-specific conditioning data in view of the subsequent dialog turns between the user and the application.

12. The method of claim 1, wherein the user-specific conditioning data comprises mappings from particular portions of the user-specific conditioning data to past dialog turns between the user and the application that spawned the particular portions of the user-specific conditioning data.

13. The method of claim 12, wherein the past dialog turns are stored as one or more entries in a log.

14. The method of claim 13, further comprising using the mappings to alter the one or more entries of the log based on the new dialog turns between the user and the application.

15. The method of claim 1, wherein the user-specific conditioning data comprises mappings from particular portions of the user-specific conditioning data to past user interaction data that spawned the particular portions of the user-specific conditioning data.

16. The method of claim 15, further comprising using the mappings to alter the past user interaction data.

17. The method of claim 16, wherein the past user interaction data comprises one or more of:
commissioning a new smart appliance into a coordinated ecosystem of smart appliances associated with the user;
altering a configuration of a smart appliance within the coordinated ecosystem; or
decommissioning a smart appliance from the coordinated ecosystem.

18. A system comprising one or more processors and memory storing instructions that, in response to execution of the instructions by the one or more processors, cause the one or more processors to:
assemble, as a first input prompt, data indicative of:
a user-specific conditioning data, wherein the user-specific conditioning data was built over time based on past user interactions between a user and one or more computing devices; and
one or more new dialog turns between the user and an application that provides access to one or more generative models, wherein the generative model was conditioned on the user-specific conditioning data during the one or more new dialog turns, and the one or more new dialog turns are more recent than the user-specific conditioning data;
process the first input prompt using one or more of the generative models to generate first generative model output, wherein the first generative model output identifies one or more portions of the user-specific conditioning data that are out-of-date in view of the one or new dialog turns between the user and the application;
based on one or more of the portions of user-specific conditioning data that are identified as out-of-date, update, and store for subsequent use when the user submits a new generative model query, updated user-specific conditioning data that reflects one or more of the of the new dialog turns between the user and the application.

19. The system of claim 18, wherein the instructions to update comprise instructions to:
assemble, as a second input prompt, data indicative of:
the one or more portions of the user-specific conditioning data identified as out-of-date, and
one or more of the new dialog turns between the user and the application; and
process the second input prompt using one or more of the generative models to generate second generative model output, wherein the second generative model output comprises new versions of the one or more identified portions of the user-specific conditioning data.

20. At least one transitory or non-transitory computer-readable medium comprising instructions that, in response to execution of the instructions by one or more processors, cause the one or more processors to:
assemble, as a first input prompt, data indicative of:
a user-specific conditioning data, wherein the user-specific conditioning data was built over time based on past user interactions between a user and one or more computing devices; and
one or more new dialog turns between the user and an application that provides access to one or more generative models, wherein the generative model was conditioned on the user-specific conditioning data during the one or more new dialog turns, and the one or more new dialog turns are more recent than the user-specific conditioning data;
process the first input prompt using one or more of the generative models to generate first generative model output, wherein the first generative model output identifies one or more portions of the user-specific conditioning data that are out-of-date in view of the one or new dialog turns between the user and the application;
based on one or more of the portions of user-specific conditioning data that are identified as out-of-date, update, and store for subsequent use when the user submits a new generative model query, updated user-specific conditioning data that reflects one or more of the of the new dialog turns between the user and the application.
